(19) United States
(12) Patent Application Publication
(10) Pub. No.: US 2014/0222820 A1
(43) Pub. Date: Aug. 7, 2014

(54) APPARATUS, SYSTEM, AND METHOD FOR VEHICULAR CHARACTERISTIC MONITORING AND CATALOGING

(71) Applicants: Gary Alan Mott, Loxahatchee, FL (US); Laurie Adriane Conn, Highland Beach, FL (US); Ronald Lawrence Breslofsky, Boca Raton, FL (US); Santiago Alberto Ramirez, Lake Worth, FL (US); Ronald Sanders, Simi Valley, CA (US)

(72) Inventors: Gary Alan Mott, Loxahatchee, FL (US); Laurie Adriane Conn, Highland Beach, FL (US); Ronald Lawrence Breslofsky, Boca Raton, FL (US); Santiago Alberto Ramirez, Lake Worth, FL (US); Ronald Sanders, Simi Valley, CA (US)

(21) Appl. No.: 14/075,167

(22) Filed: Nov. 8, 2013

Related U.S. Application Data
(60) Provisional application No. 61/761,047, filed on Feb. 5, 2013.

(51) Int. Cl. G06F 17/30

(52) U.S. Cl. CPC G06F 17/30598
USPC 707/740

(57) ABSTRACT

The present disclosure is directed to a mobile device for reporting at least one characteristic of at least one vehicle. The mobile device includes at least one input device, at least one transmitting device configured to transmit the at least one characteristic of the at least one vehicle to a second device, at least one storage device for storing data, and a module stored on the at least one storage device, the module executable by the mobile device and configured to accept user inputs from the at least one input device and catalog each user input with respect to an identified vehicle by causing the apparatus to perform the steps of: generating a first user interface (UI) at least including a field to input an identification data of the identified vehicle; receiving characteristic data from the input device relating to the at least one characteristic of the identified vehicle; and transmitting the characteristic data with reference to the identified vehicle to a database.

### CROSS-REFERENCE TO RELATED APPLICATION

The present application claims the benefit of and priority to U.S. Provisional Application Ser. No. 61/761,047 filed on Feb. 5, 2013, the entire contents of which being incorporated by reference herein.

### TECHNICAL FIELD

The present disclosure relates to vehicular monitoring, vehicular databasing, vehicular valuation, vehicular condition reporting, and vehicular quality tracking, and in particular to a system for monitoring and tracking vehicular quality.

### BACKGROUND

Monitoring and valuation of a fleet of vehicles can be a tedious process that may require someone to manually evaluate each vehicle of a fleet. The larger the fleet, the harder such a process is to manage and maintain, and possibly the more inefficient/inaccurate the process becomes. With larger fleets, individual reporting of vehicular condition/value may take place in a variety of modes which lack uniformity, as well as in a variety of locations which leads to disconnected information regarding each portion of a given fleet. Presently, consolidating all of the information regarding the fleet consumes a large amount of time and is riddled with inefficiency.

### SUMMARY

In at least one aspect of the present disclosure, a mobile device for reporting at least one characteristic of at least one vehicle includes at least one input device configured to record the at least one characteristic of the at least one vehicle input by a user, at least one transmitting device configured to transmit the at least one characteristic of the at least one vehicle to a second device, at least one storage device for storing data, and a module stored on the at least one storage device. The module is executable by the mobile device and configured to accept user inputs from the at least one input device and catalog each user input with respect to an identified vehicle by causing the apparatus to perform the steps of generating a first user interface (UI) at least including a field to input an identification data of the identified vehicle, receiving characteristic data from the input device relating to the at least one characteristic of the identified vehicle, and transmitting the characteristic data with reference to the identified vehicle to a database.

In at least one aspect of the present disclosure, the at least one input device includes a touch screen.

In at least one aspect of the present disclosure, the at least one input device further includes an imaging device.

In at least one aspect of the present disclosure, the identification data is a VIN of a vehicle.

In at least one aspect of the present disclosure, the module further causes the apparatus to perform the step of generating a second user interface for inputting the characteristic data after the identification has been input into the first user interface.

In at least one aspect of the present disclosure, a system for valuing at least one vehicle includes a mobile device having executable software configured to catalog at least one characteristic of the at least one vehicle and to transmit the at least one characteristic of the at least one vehicle to a remote database, a second device including the remote database and configured to receive data from the mobile device, and a valuation module executable by at least one of the first device, the second device, or a third device, wherein the valuation module is configured to produce a valuation of the at least one vehicle based on the at least one characteristic.

In at least one aspect of the present disclosure, a location tracker is included with the system and configured to relay location information relating to the at least one vehicle to the remote database.

In at least one aspect of the present disclosure, the valuation module is configured to modify the valuation of the at least one vehicle based on market considerations relating to a location of the at least one vehicle.

In at least one aspect of the present disclosure, a characteristic tracking device is included with the system and is configured to relay characteristic data of the at least one vehicle selected from the group consisting of mileage, engine time, and engine condition.

In at least one aspect of the present disclosure, the at least one vehicle is a fleet of vehicles, wherein the valuation software produces a real time portfolio analysis of the fleet of vehicles based on the characteristic data.

In at least one aspect of the present disclosure, the characteristic data includes at least one vehicular information selected from the group consisting of a mileage, a year of manufacture, a vehicle type, a vehicle make, a damage type, a paint quality, an interior quality, a mechanical quality, a maintenance record or lack thereof, and an estimate of damage or depreciation.

In at least one aspect of the present disclosure, a non-transitory computer readable medium includes a computer-executable list of instructions which, when executed on a processor, perform a method including the steps of generating at least one user interface configured to receive an identification data and/or a characteristic data of a vehicle, receiving the identification data, receiving the characteristic data, cataloging the characteristic data with the identification data, and transmitting the catalog characteristic data to a vehicular database configured to produce a value of the vehicle based on the characteristic data.

In at least one aspect of the present disclosure, the computer-executable list of instructions further include instructions for communicating with the vehicular database after receiving the identification data to verify the existence of the identification data in the vehicular database.

In at least one aspect of the present disclosure, receiving the characteristic data may only occur after the communicating step returns a verification.

In at least one aspect of the present disclosure, the generating step further includes providing at least one field for numerically rating at least one characteristic of the vehicle.

In at least one aspect of the present disclosure, the generating step further includes providing at least one field for selecting a quality rating of at least one characteristic of the vehicle.

In at least one aspect of the present disclosure, the identification data is a Vehicle Identification Number (VIN), the list of instructions further including communicating with the vehicular database to verify that the VIN is stored thereon, wherein if the VIN is stored on the vehicular database, the generating step further includes providing at least one field for numerically rating or qualifying at least one subjective characteristic of the vehicle, wherein the generating step further includes providing at least one field for inputting at least one objective characteristic of a vehicle, wherein if the VIN is not stored on the vehicular database, the list of instructions further includes displaying an error message.

In at least one aspect of the present disclosure, the computer-executable list of instructions further include instructions for receiving, cataloging, and transmitting images to the database, the images captured by an image capturing device on a mobile device.

In at least one aspect of the present disclosure, a method for tracking the value of a plurality of vehicles includes receiving identification data and characteristic data of a plurality of vehicles from a mobile device, cataloging, in an electronic database, the identification data and the characteristic data corresponding to each vehicle, receiving the characteristic data from the electronic database, computing a value of each vehicle based on the characteristic data, and outputting an appraisal of each vehicle.

### BRIEF DESCRIPTION OF THE DRAWINGS

The above and other aspects, features, and advantages of the present disclosure will become more apparent in view of the following detailed description when taken in conjunction with the accompanying drawings in which:

FIG. 1 is a diagrammatic view of a system in accordance with an embodiment of this disclosure;

FIG. 2 is a schematic view of a mobile device in accordance with this disclosure;

FIG. 3 is a schematic view of a second device in accordance with this disclosure;

FIGS. 4A-4L are examples of graphical user interfaces and displays for use with the mobile device of FIG. 2, in accordance with this disclosure;

FIG. 5 is an example display view of a graphical user interface and displays for use with the second device of FIG. 3, in accordance with this disclosure;

FIG. 6 is a diagrammatic view of software system in accordance with this disclosure; and

FIG. 7 is a flow chart of a method in accordance with this disclosure.

### DETAILED DESCRIPTION

Particular embodiments of the present disclosure are described with reference to the accompanying drawings; however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure. In this description, as well as in the drawings, like-referenced numbers represent elements which may perform the same, similar, or equivalent functions.

Additionally, the present disclosure may be described in terms of functional block components, code listings, optional selections, page displays, and various processing steps. It should be appreciated that such functional blocks may be realized by any number of hardware and/or software components configured to perform the specified functions. For example, embodiments of the present disclosure may employ various integrated circuit components, e.g., memory elements, processing elements, logic elements, look-up tables, and the like, which may carry out a variety of functions under the control of one or more microprocessors or other control devices.

Similarly, the software elements of embodiments of the present disclosure may be implemented with any programming or scripting language such as C, C++, C#, Java, COBOL, assembler, PERL, Python, PHP, or the like, with the various algorithms being implemented with any combination of data structures, objects, processes, routines or other programming elements. The object code created may be executed on a variety of operating systems including, without limitation, Windows®, Macintosh OSX®, iOS®, linux, and/or Android®.

Further, it should be noted that embodiments of the present disclosure may employ any number of conventional techniques for data transmission, signaling, data processing, network control, and the like. It should be appreciated that the particular embodiments shown and described herein are illustrative of the disclosure and its best mode, and are not intended to otherwise limit the scope of the present disclosure in any way. Examples presented herein which include sample data items (e.g., names, dates, etc.) are intended as examples and are not to be construed as limiting. Indeed, for the sake of brevity, conventional data networking, application development and other functional aspects of the systems (and components of the individual operating components of the systems) may not be described in detail herein. Furthermore, the connecting lines shown in the various figures contained herein are intended to represent example functional relationships and/or physical or virtual couplings between the various elements. It should be noted that many alternative or additional functional relationships or physical or virtual connections may be present in a practical electronic data communications system.

As will be appreciated by one of ordinary skill in the art, the present disclosure may be embodied as a method, a data processing system, a device for data processing, and/or a computer program product. Accordingly, the present disclosure may take the form of an entirely software embodiment, an entirely hardware embodiment, or an embodiment combining aspects of both software and hardware. Furthermore, the present disclosure may take the form of a computer program product on a computer-readable storage medium having computer-readable program code means embodied in the storage medium. Any suitable computer-readable storage medium may be utilized, including hard disks, CD-ROM, DVD-ROM, optical storage devices, magnetic storage devices, semiconductor storage devices (e.g., USB thumb drives) and/or the like.

Embodiments of the present disclosure are described with reference to block diagrams and flowchart illustrations of methods, apparatus (e.g., systems), and computer program products according to various aspects of the disclosure. It will be understood that each functional block of the block diagrams and the flowchart illustrations, and combinations of functional blocks in the block diagrams and flowchart illustrations, respectively, may be implemented by computer program instructions. These computer program instructions may be loaded onto a general purpose computer, special purpose computer, mobile device or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, may be implemented by either special purpose hardware-based computer systems that perform the specified functions or steps, or suitable combinations of special purpose hardware and computer instructions.

One skilled in the art will also appreciate that, for security reasons, any databases, systems, or components of the present disclosure may consist of any combination of databases or components at a single location or at multiple locations, wherein each database or system includes any of various suitable security features, such as firewalls, access codes, encryption, de-encryption, compression, decompression, and/or the like.

References made to the example embodiments illustrated in the drawings, and specific language describing the same, is for the purposes of promoting an understanding of the principles of the present disclosure. It should be understood that no element is essential to the practice of the disclosure unless specifically described herein as “critical” or “essential.” Moreover, the steps recited in any method claims may be executed in any order and are not limited to the order presented in the claims.

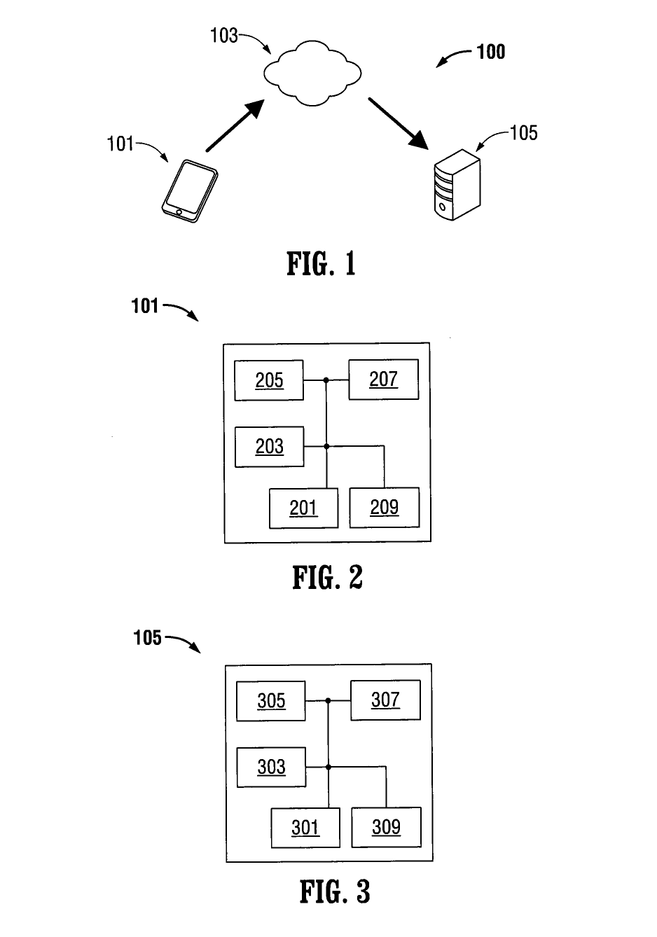

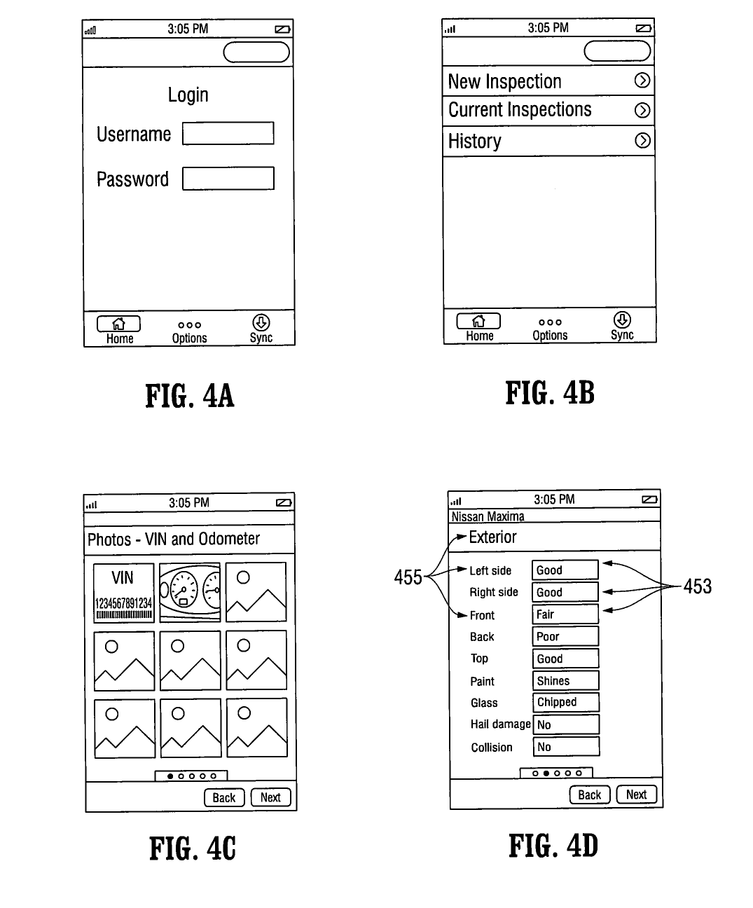

Referring initially to FIGS. 1 and 2, the system 100 includes one or more mobile devices 101 having components that are configured to connect to a remote server 103. The remote server 103 is connected to a second device 105 such as, but not limited to, one or more personal computers, one or more receiving mobile devices, or one or more other servers.

The mobile device 101 may be any type of mobile computer, such as a mobile phone, tablet, laptop, etc. With additional reference to FIG. 2, the mobile device 101 includes one or more storage devices 201 for locally storing data, and one or more input devices 203 for receiving user inputs such as, but not limited to a touch-screen or keyboard. The mobile device 101 further includes one or more transmission units 205 for transmitting and receiving data to/from another device, one or more display devices 207, and one or more processors 209.

Storage device 201, and any other memory or storage device described herein, may include, without limitation, a repository, a databank, a database, a cache, a storage unit, a “cloud”, and the like, a data repository, any computer or other machine-readable data storage medium, memory device or other storage or communication device for storage or communication of information, currently known or which becomes available in the future, including, but not limited to, an integrated circuit, a memory portion of an integrated circuit (such as the resident memory within a processor), whether volatile or non-volatile, whether removable or non-removable, including without limitation RAM, FLASH, DRAM, SDRAM, SRAM, MRAM, FeRAM, ROM, EPROM or E2PROM, or any other form of memory device, such as a magnetic hard drive, an optical drive, a magnetic disk or tape drive, a hard disk drive, other machine-readable storage or memory media such as a floppy disk, a CDROM, a CD-RW, digital versatile disk (DVD) or other optical memory, or any other type of memory, storage medium, or data storage apparatus or circuit, which is known or which becomes known, depending upon the selected embodiment.

Additionally, or alternatively, such computer readable media includes any form of communication media which embodies computer readable instructions, data structures, program modules or other data in a data signal or modulated signal, such as an electromagnetic or optical carrier wave or other transport mechanism, including any information delivery media, which may encode data or other information in a signal, wired or wirelessly, including electromagnetic, optical, acoustic, RF or infrared signals, etc.

The term “processor”, as used herein, may be any type of controller or processor, and may be embodied as one or more controllers or processors adapted to perform the functionality discussed herein. Additionally, as the term processor is used herein, a processor may include use of a single integrated circuit (IC), or may include use of a plurality of integrated circuits or other components connected, arranged or grouped together, such as controllers, microprocessors, digital signal processors, parallel processors, multiple core processors, custom ICs, application specific integrated circuits, field programmable gate arrays, adaptive computing ICs, associated memory, such as and without limitation, RAM, DRAM and ROM, and other ICs and components.

Mobile device 101 may also include one or more imaging systems (not shown) operably connected to the input device 203 such that mobile device 101 may receive an image from the imaging device and either store the image in storage device 201 or transmit the image to a remote storage unit (not shown).

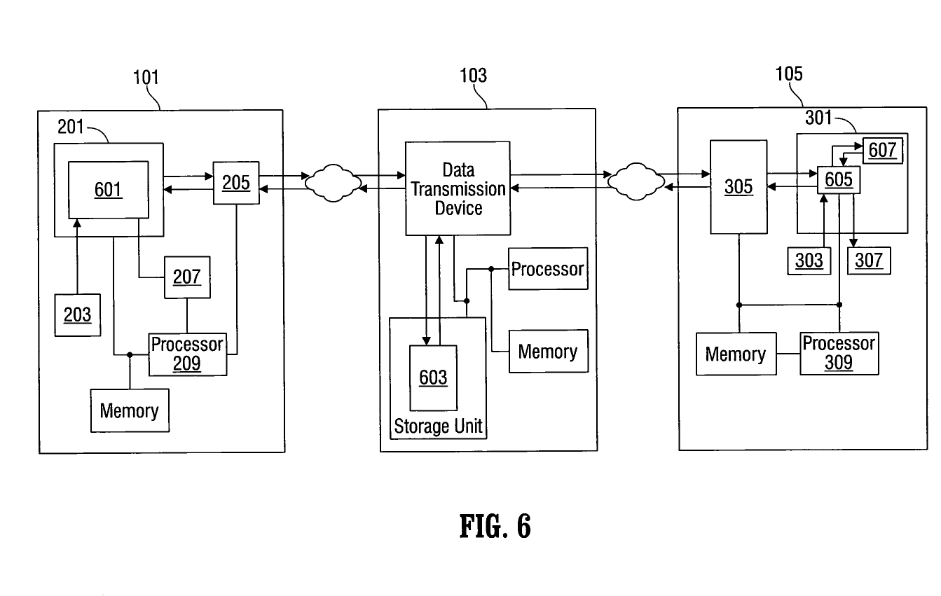

With additional reference to FIG. 6, mobile device 101 further includes a first module 601 having a computer readable list of instructions stored on storage device 201. As used herein, the term “module” is understood to include any computer readable instructions such as software written in any software language or software code known now, or that which may become available in the future.

The first module 601 includes instructions that allow mobile device 101 to receive information regarding one or more vehicular characteristics via input devices 203 and then upload the characteristic information cataloged with respect to the identified vehicle to a database 603 stored on either the remote server 103 or the second device 105 via transmission unit 205. The mobile device 101 may connect either directly to the remote server 103 or second device 105 using a wireless transmission system including satellites, microwave towers, or the like, or indirectly through one or more external servers. As shown in FIG. 1, mobile device 101 uploads data to remote server 103 which contains the database 603, which is then accessed by the second device 105, either wirelessly or via a cable connection.

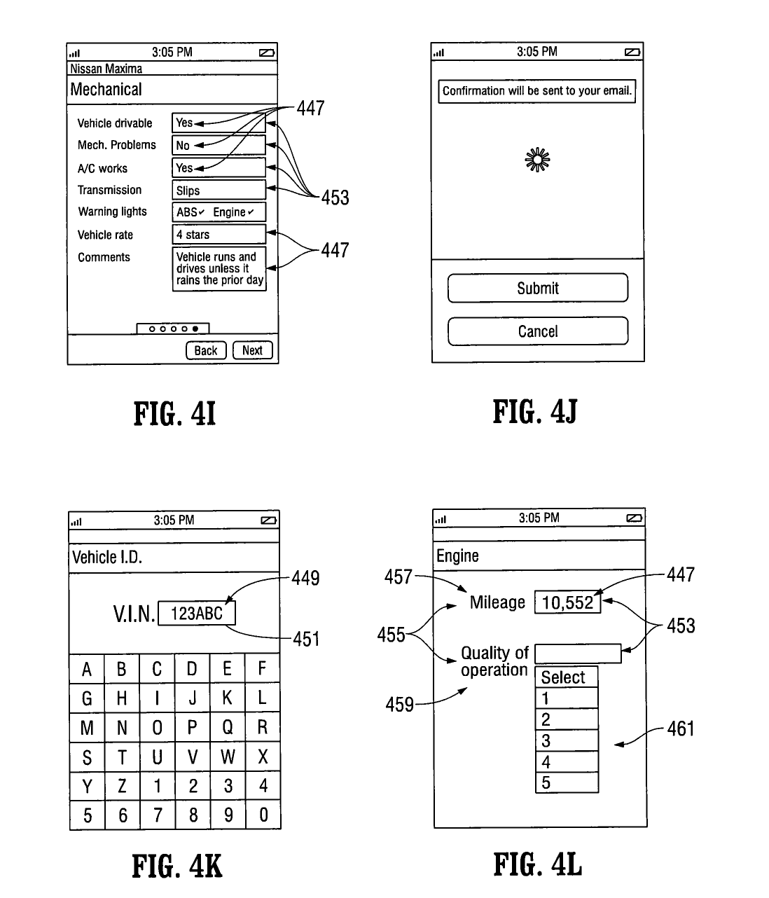

The first module 601 may also include instructions for generating one or more user interfaces (UI) to provide data input fields as described herein. FIGS. 4A-4L show examples of different user interface screens that the first module 601 may generate and display on display device 207.

Referring to FIGS. 4A-4L, the one or more UIs may include one or more identification fields 451 for input of vehicle identification data 449 such as, but not limited to, a vehicle identification number (VIN), a serial number, or any other information indicative of an individual vehicle. The one or more UIs may also include one or more characteristic fields 453 for inputting a characteristic of a vehicle, such as, but not limited to mileage, year of manufacture, vehicle type, vehicle make, damage type or history, exterior paint quality, interior quality, mechanical quality, maintenance/inspection records or lack thereof, and an estimate of damage or depreciation.

One or more UIs may be generated in a plurality of separately accessible screens or in one screen configured to either fit within the confines of display device 207 or which has portions of the one or more UIs available via scrolling, swiping, or transitioning in any suitable manner using the input device 203.

The one or more characteristic fields 453 include a label 455 that describes the characteristic to be inputted, and the UI is configured to allow input of words or numerical values that relate to the labeled characteristic. For example, an objective characteristic 457 may be entered in directly, such as, but not limited to, a mileage indicated on an odometer. However, subjective characteristics 459, such as overall appearance or appeal, may be entered in using a predetermined scale. The predetermined scale may require input of a numerical value or qualifying word assigned by the user to the quality of a subjective characteristic. For example, when inputting data relating to the quality of a paint job of a vehicle (a subjective characteristic), the user may be required to enter a number between, for example, 1 and 10, or a qualifying word or phrase regarding condition such as “good,” “bad,” “excellent,” etc.

The first module 601 may require the user to type the description into the characteristic field 453 and store the input if it is a recognized number or qualifying word/phrase of the predetermined scale. In other embodiments, the first module 601 may generate a list 461 of selectable numbers or qualifying words/phrases of a predetermined scale that the user may select from using the input device 203 after selecting a particular characteristic field 453 that is labeled with a subjective characteristic 459.

Once identification data 449 is input into the identification field 451, the first module 601 may instruct the mobile device 101 to perform a check to see if the identification data 449 is already stored on an electronic database 603 stored on either the remote server 103 or the second device 105. In some embodiments, the first module 601 may require the identification data 449 to be already stored on the database 603 before vehicle characteristics can be entered. In this instance, if the identification data 449 is already listed on the database 603, then the first module 601 allows characteristic data 447 to be inputted into the one or more characteristic fields 453. However, if the identification data 449 is not recognized as valid and/or is not stored in the database 603, the first module 601 prevents display and/or use of the one or more characteristic fields. Also, in the event that the identification data 449 is not recognized as valid, and/or is not stored in the database 603, the first module 601 may generate an error message on the display device 205. Further, when the identification data 449 is not recognized and/or not included on the database 603, the first module 601 may return an error message on display device 207 that queries the user to enter additional information of the unrecognized identification data 449 to the database 603.

For example, in such embodiments, if a user inputs a VIN into the identification field, if the VIN is not already on the database 603 the user may be informed that the VIN is not stored on the database 603 and then asked whether the user would like to add the VIN to the database 603 by using a selection interface generated by the first module 601. This would allow the user to override errors in the database 603 where there is incorrect or missing information in the database 603. If the user chooses to add the identification data 449 to the database 603, the first module 601 may then generate/allow the use of the one or more characteristic fields 453. In the event the user selects to not add the identification data 449 to the database 603, the first module 601 may continue to display or re-generate the identification field 451 either blanked (possibly including phantom messages) or containing the previously entered identification data 449.

In other embodiments, the first module 601 may generate/allow the use of the one or more characteristic fields 453 without checking the identification data 449 or in the circumstance the input identification data 449 is incorrect and/or not included in the electronic database 603. Similar options as described above may be included such as a query to request additional information to be added to the database 603 in the event of the identification data 449 of the vehicle not being recognized or included on the database 603. However, in some embodiments, in the event the user selects to not add missing identification data 449 to the database 603, the first module 601 may prevent generation and/or use of one or more characteristic fields 453.

Alternatively, in other embodiments, in the event the user selects to not add missing identification data 449 to the database 603, the first module 601 may generate/allow the use of the one or more characteristic fields 453 without specific identification data 449. In this case, the first module 601 may generate an ID code to catalog any characteristic information input by the user into the one or more characteristic fields 453. The first module 601 may be configured to allow the user to change the ID code or replace it with identification data 449 before or after characteristic information is received. Also, the ID code may be changed after being added to the database 603 by accessing the database 603 using the mobile device 101 or the second device 105.

In some instances, mobile device 101 may not be able to establish a connection with the database 603 on the remote server 103 and/or second device 105, in which case the first module 601 may catalog and store vehicle identification data 449 and characteristic data 447 locally on storage device 201 at least until a connection with remote server 103 and/or second device 105 is established. The first module 601 may automatically, or after input from the user, instruct the transmission unit 207 of the mobile device 101 to transmit the vehicle identification data 449 and characteristic information to the database 603 when a connection, direct or indirect, is established.

A user/device authentication routine may also be included in the first module 601 that is configured to verify the credentials of the mobile device and/or the user to access the database 603. The first module 601 may generate an authentication field to prompt the user to input authentication information before generating/allowing use of the vehicular identification field or the one or more characteristic fields. The first module 601 may cross-reference the user input authentication information against approved authentication information that may be stored locally on storage device 201 and/or remotely on an external device such as, but not limited to, remote server 103 and second device 105.

If the user authentication data is not registered, the first module 601 may prompt the user to register the mobile device 101 and/or user information. Alternatively, a user may be required to preregister in an authentication database 603 before gaining access to the data input portions of the first module 601. In some embodiments, the user may be allowed to create a condition report by entering data into the identification and characteristics fields, but be unable to upload the data to the database 603 until registration is complete. Registration data that may be entered includes, but is not limited to, company name, first and last name, phone and email, and/or a unique device identifier.

After a user inputs all desired data, the user may submit the data via one or more submission user interfaces such as shown in FIG. 4J. Upon submission, the user may be provided with a notification or confirmation that the data was correctly submitted and/or transmitted to database 603. For example, the system may be configured to automatically generate an email or other message to notify the user that the data was submitted, submission was successful, data transmission was successful, and/or the like.

Referring back to FIGS. 1 and 6, remote server 103 may be any type of electronic device, mobile or otherwise, having at least a transmission unit configured to receive and send data and a storage device for remotely storing data. For example, remote server 103 may be a personal computer (PC), mobile device similar to mobile device 101, or any other form of server or relay that is suitable for use with remote computing. The remote server 103 includes one or more processors and one or more storage units (e.g. storage unit and memory as shown in FIG. 6). Embodiments of remote server 103 may include one or more servers that may be connected to and/or form part of the internet, a “cloud” computing service, or any other suitable means.

As disclosed above, remote server 103 may include the database 603 stored thereon. The database 603 may be any arrangement of information configured to store at least vehicular information data in a cataloged manner, such as, but not limited to, a digital spreadsheet. For example, the database 603 may include at least a data field for identification data 449 and one or more data fields for vehicular characteristic information as described above.

As shown in FIG. 1, remote server 103 is configured to receive data from mobile device 101. When receiving data from mobile device 101, the remote server 103 is programmed to input data into the database 603, or to allow direct input from the mobile device 101. The remote server 103 is configured to, either automatically or upon request, send a copy of the database 603, database 603 updates, or simply allow access to the database 603 by the second device 105.

Second device 105 may be any electronic device, mobile or otherwise, having at least a transmission unit configured to receive data and a display unit for displaying data. For example, remote server 103 may be a personal computer (PC), mobile device similar to mobile device 101, or any other form of server that is suitable for use with remote computing.

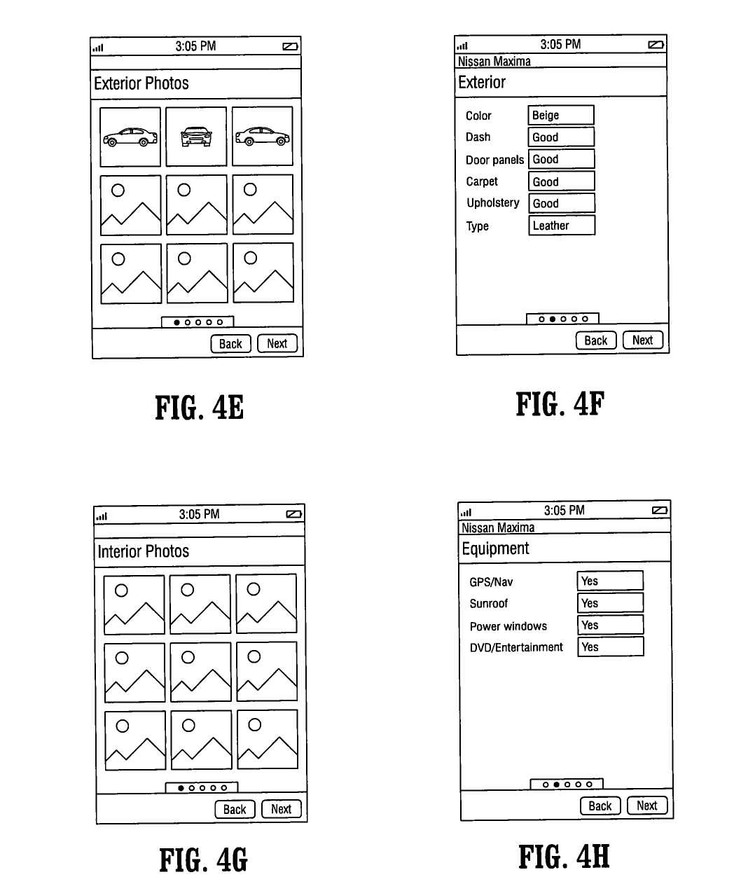

Referring to the embodiment shown in FIG. 3, second device 105 includes one or more storage devices 301, one or more input devices 303, one or more transmission devices 305, one or more display device 307, and one or more processors 309. With additional reference to FIG. 6, second device 105 may include a second module 605 stored thereon including computer executable instructions for accessing and displaying the vehicle database 603 and/or receiving data from the mobile device 101 or the remote server 103. A user/device authentication routine may also be included in the second module 605 that is configured to verify the credentials of the second device 105 and/or user to access the database 603. The second module 605 may generate an authentication field to prompt the user to input authentication information before allowing access and/or displaying the database 603. The second module 605 may cross-reference the user input authentication information against approved authentication information that may be stored locally on storage device 301 and/or remotely on an external device such as, but not limited to, remote server 103. The user and device information may be used to limit access to certain portions of the database 603 that are assigned to a specified group to which the user is associated.

Alternatively, the second module 605 may be stored on the one or more remote servers 103, implemented in the form of a web application, and accessed via an internet connection by second device 105.

As disclosed above, the database 603 may be stored locally on the second device 105 instead of on the remote server 103. In such instances, remote server 103 may act simply as a data relay between the mobile device 101 and the second device 105. Alternatively, remote server 103 may be eliminated as a component to system 100 and instead have mobile device 101 directly communicating with the second device 105 via a wireless signal, wired connection, or via a wireless network such as a satellite system or cell tower system.

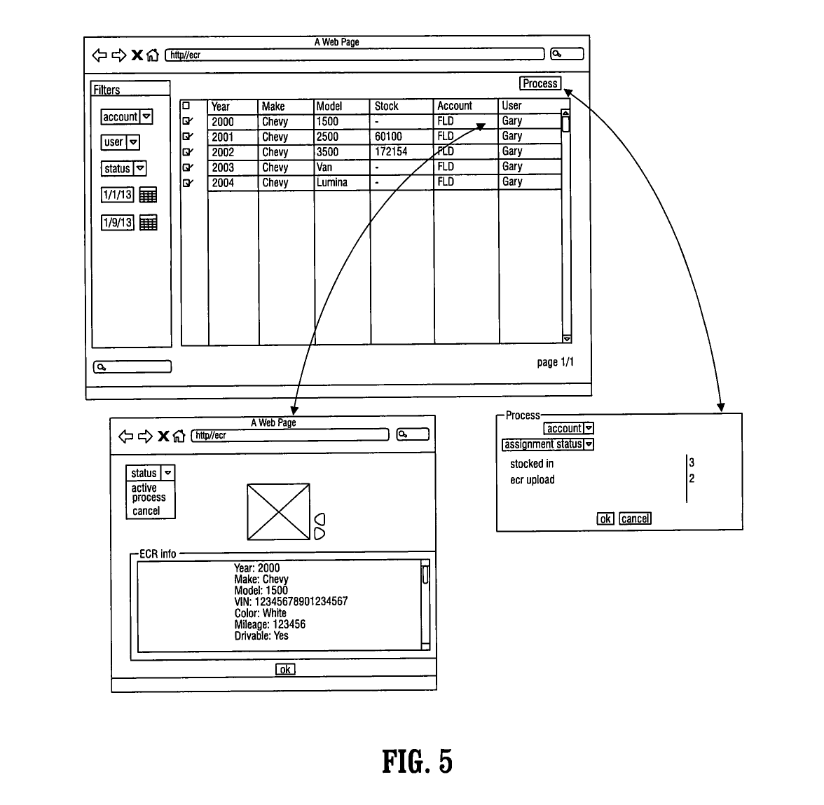

The second device 105 allows a user to access the database 603 to add, remove, change, copy, or evaluate data contained therein. The second module 605 may generate a UI for the second device 105 as shown by way of example in FIG. 5. There may be several selection fields associated with the UI of the second device 105 such as, but not limited to, data filters for limiting a displayed list of the database 603 to vehicles uploaded by a particular user, within a date range, by account number, by status of the vehicle, etc. The UI may display units by status such as, but not limited to “Active,” “Processed,” and “Canceled.” Active units may be those that have been uploaded by the mobile device 101 but the data has yet to be entered into the database 603. Processed units may be those that have been included in the database 603. Canceled units may be those that have been uploaded by the mobile device 101 but will not be included in the database 603. The second module 605 may again perform a check for overlapping vehicle identification data 449 and may notify the user when there is such an occurrence.

Analysis may be performed on any portion of the data contained in the database 603. For example, a valuation module 607 may be stored on the storage device 301 and may be configured to produce a condition/value of a vehicle based on the characteristic data 447 stored in the database 603. A price, value, and or condition may be assigned to each vehicle in the database 603 by the valuation module 607.

More specifically, the valuation module 607 may include instructions to read the data in each characteristic field of the database 603 cataloged to individual vehicles. The valuation module 607 may then input the data into a valuation algorithm which weighs each characteristic of the vehicle against a predetermined or generated starting value. The algorithm generates a value for the identified vehicle in its current state. That value can than be uploaded to the database 603 for that vehicle or be uploaded to a separate database. The valuation module 607 may further aggregate all values of a fleet of desired vehicles to estimate the value of an entire fleet and analyze/display changes in that value.

The valuation module 607 may also include an accuracy enhancing subroutine to more closely approximate the value assigned to each vehicle to the actual market value of the vehicle. The purpose of this subroutine is to eliminate user bias for subject criteria. For example, one user may consistently rate subjective qualities (like paint job or interior quality) lower than appropriate, which would artificially bring down the projected value/condition of the vehicle. The accuracy enhancing subroutine can notice patterns based on sales data (what price a vehicle actually sold for and which user rated that vehicle) stored somewhere on system 100 or be manually programmed to account for a particular users bias by reducing or increasing the weight given to each of the subjective characteristics in the valuation algorithm. Thus, subjective ratings may be modified based on the user that rated the vehicle by the valuation module 607 before inputting the data into the valuation algorithm based on empirical data which indicates the accuracy of each registered user.

While the valuation module 607 has been described as being stored on and executable by the second device 105 (FIG. 6), the valuation module 607 may also be stored on and executable by any combination of devices in system 100. For example, the mobile device 101 may include a valuation module 607 that calculates the value of each vehicle and uploads the values to the database 603. In some embodiments, the valuation module 607 is stored on the remote server 103 with the database 603 and is accessible, along with the database 603, by the second device 105 and/or by the mobile device 101.

The system 100 may further include one or more location trackers (not shown), such as a GPS unit, configured to relay location information relating to a vehicle to the remote database 603. The location information may be uploaded in real time, be delayed, be uploaded at intermittent intervals, and/or be uploaded at request of the device (e.g. remote server 103) which stores the database 603. Similar to other characteristics, the valuation module 607 can account for market factors relating to location of the vehicle provided by the location tracker when determining the value of a vehicle.

The system 100 may also include one or more characteristic tracking devices configured to relay characteristic data 447 of a vehicle. The characteristic information may be uploaded by the characteristic tracker in real time, be delayed, or be uploaded at intermittent intervals and/or at request of the device containing the database 603. The characteristic tracker may be a device installed on a vehicle that can read and transmit characteristics such as, but not limited to, mileage, engine time, and engine condition. In this case, the database 603 can be automatically updated to include updated information for each vehicle thereby increasing the accuracy of the valuation module 607.

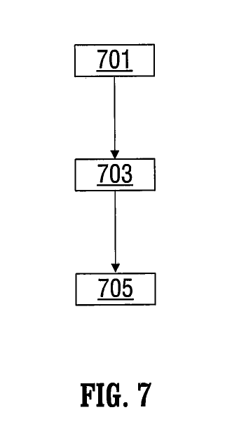

Referring to FIG. 7, the present disclosure also relates to a method for tracking the value of a plurality of vehicles. The method includes the initial step 701 of receiving identification data 449 and characteristic data 447 of a plurality of vehicles from a mobile device 101. After receiving data 447, 449, the method includes step 703 which includes cataloging the data 447, 449 in an electronic database 603 such that the identification data 449 and the characteristic data 447 correspond to a particular vehicle. The method further includes step 705 which includes producing an appraisal of the vehicle using a valuation module 607 described herein configured to produce a value of the vehicle by a) receiving the characteristic data 447 from the database 603, b) computing a value of each vehicle based on the characteristic data 447, and c) outputting a condition appraisal or value of each vehicle.

Embodiments of the above described system, devices, modules, and methods allow users to quickly create a condition report on site for all vehicles of their fleet. This greatly speeds up the processing of quotes, employee sales, and direct purchases. The system may be configured to operate with a single fleet owner, or to be operated by a service to track fleets owned by different entities. For example, multiple different companies may outfit each of their employees with a mobile device 101, such as a cell phone, that is equipped with the first module 601. Each individual employee may send condition reports regarding vehicles in their company's fleet to the database 603. A management organization may manage and have access to the entire database 603 via the second device 105 or an external device having the second module 605. The individual companies may only be provided access to portions of the database 603 containing vehicles assigned to their fleet in order to see the condition/value of each vehicle or their entire fleet. This can be accomplished through use of the authentication system included in the second module 605.

Additionally, embodiments of the above described system, devices, modules, and methods may also be configured for consumer use to catalogue a single vehicle or a small group of vehicles owned by a user. It should be understood that embodiments of this disclosure may be configured for use with any type of vehicle including, but not limited to, cars, trucks, watercraft, aircraft, construction equipment, any other suitable machinery, and/or combinations thereof.

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawings are presented only to demonstrate certain examples of the disclosure. Other elements, steps, methods, and techniques that are insubstantially different from those described above and/or in the appended claims are also intended to be within the scope of the disclosure.

What is claimed is:

1. A mobile device for reporting at least one characteristic of at least one vehicle, comprising:
at least one input device configured to record at least one characteristic of at least one vehicle input by a user;
at least one transmitting device configured to transmit the at least one characteristic of the at least one vehicle to a second device;
at least one storage device for storing data; and
a module stored on the at least one storage device, the module executable by the mobile device and configured to accept user inputs from the at least one input device and catalog each user input with respect to an identified vehicle by causing the apparatus to perform the steps of:
generating a first user interface (UI) at least including a field to input an identification data of the identified vehicle;
receiving characteristic data from the input device relating to the at least one characteristic of the identified vehicle; and
transmitting the characteristic data with reference to the identified vehicle to a database.

2. The mobile device of claim 1, wherein the at least one input device comprises a touch screen.

3. The mobile device of claim 2, wherein the at least one input device further comprises an imaging device.

4. The mobile device of claim 1, wherein the identification data is a VIN of a vehicle.

5. The mobile device of claim 1, wherein the module further causes the apparatus to perform the step of generating a second user interface for inputting the characteristic data after the identification has been input into the first user interface.

6. A system for valuing at least one vehicle, comprising:
a mobile device having executable software configured to catalog at least one characteristic of the at least one vehicle and to transmit the at least one characteristic of the at least one vehicle to a remote database;
a second device comprising the remote database and configured to receive data from the mobile device; and
a valuation module executable by at least one of the first device, the second device, or a third device, wherein the valuation module is configured to produce a valuation of the at least one vehicle based on the at least one characteristic.

7. The system of claim 6, further comprising a location tracker configured to relay location information relating to the at least one vehicle to the remote database.

8. The system of claim 6, wherein the valuation module is configured to modify the valuation of the at least one vehicle based on market considerations relating to a location of the at least one vehicle.

9. The system of claim 6, further comprising a characteristic tracking device configured to relay characteristic data of the at least one vehicle selected from the group consisting of mileage, engine time, and engine condition.

10. The system of claim 6, wherein the at least one vehicle is a fleet of vehicles, wherein the valuation software produces a real time portfolio analysis of the fleet of vehicles based on the characteristic data.

11. The system of claim 6, wherein the characteristic data includes at least one vehicular information selected from the group consisting of a mileage, a year of manufacture, a vehicle type, a vehicle make, a damage type, a paint quality, an interior quality, a mechanical quality, a maintenance record or lack thereof, and an estimate of damage or depreciation.

12. A non-transitory computer readable medium, comprising a computer-executable list of instructions which, when executed on a processor, perform a method comprising the steps of:
generating at least one user interface configured to receive an identification data and/or a characteristic data of a vehicle;
receiving the identification data;
receiving the characteristic data;
cataloging the characteristic data with the identification data; and
transmitting the cataloged characteristic data to a vehicular database configured to produce a value of the vehicle based on the characteristic data.

13. The non-transitory computer readable medium of claim 12, wherein the computer-executable list of instructions further include instructions for communicating with the vehicular database after receiving the identification data to verify the existence of the identification data in the vehicular database.

14. The non-transitory computer readable medium of claim 13, wherein receiving the characteristic data may only occur after the communicating step returns a verification.

15. The non-transitory computer readable medium of claim 12, wherein the generating step further includes providing at least one field for numerically rating at least one characteristic of the vehicle.

16. The non-transitory computer readable medium of claim 12, wherein the generating step further includes providing at least one field for selecting a quality rating of at least one characteristic of the vehicle.

17. The non-transitory computer readable medium of claim 12, wherein the identification data is a Vehicle Identification Number (VIN), the list of instructions further comprising communicating with the vehicular database to verify that the VIN is stored thereon, wherein if the VIN is stored on the vehicular database, the generating generating step further includes providing at least one field for numerically rating or qualifying at least one subjective characteristic of the vehicle, wherein the generating step further comprises providing at least one field for inputting at least one objective characteristic of a vehicle, wherein if the VIN is not stored on the vehicular database, the list of instructions further includes displaying an error message.

18. The non-transitory computer readable medium of claim 12, wherein the computer-executable list of instructions further include instructions for receiving, cataloging, and transmitting images to the database, the images captured by an image capturing device on a mobile device.
